(19) United States
(12) Patent Application Publication
(10) Pub. No.: US 2011/0234370 A1
(43) Pub. Date: Sep. 29, 2011

(54) USER IDENTIFICATION DEVICE

(76) Inventors: Stephanie Briese, Regensburg (DE); Ulrich Emmerling, Kelheim (DE); Alexander Kramer, Regenstauf (DE); Arnd Stielow, Regensburg (DE)

(21) Appl. No.: 12/671,554

(22) PCT Filed: Jul. 28, 2008
(86) PCT No.: PCT/EP08/59851

§ 371 Date: Feb. 1, 2010

(30) Foreign Application Priority Data
Jul. 31, 2007 (DE) 10 2007 035 904.9

(51) Int. Cl. G05B 19/00

(52) U.S. Cl. 340/5.6

(57) ABSTRACT

A user identification device for an access system and/or starting system of a vehicle has an energy source such as a battery or an accumulator for making available a supply voltage. In addition, there are provided a measuring device for sensing the supply voltage currently made available by the energy source and an open-loop control and evaluation device for comparing the sensed current supply voltage with a first predetermined threshold value voltage and for detecting at least one function of a plurality of functions which can be carried out by the open-loop control and evaluation device when the current sensed supply voltage drops below the first predetermined threshold value voltage. By deactivating specific functions when the energy source becomes weak while other specific functions remain activated, the critical state of the energy source of the user identification device can be signaled to a user without additional display devices being necessary.

### CROSS-REFERENCE TO RELATED APPLICATIONS

This application is a U.S. National Stage Application of International Application No. PCT/EP2008/059851 filed Jul. 28, 2008, which designates the United States of America, and claims priority to German Application No. 10 2007 035 904.9 filed Jul. 31, 2007, the contents of which are hereby incorporated by reference in their entirety.

### TECHNICAL FIELD

The present invention relates to a user identification device for an access system and/or starting system of a vehicle, in particular of a motor vehicle, as well as a method for operating such a user identification device.

### BACKGROUND

In order to prevent unauthorized access to a vehicle, modern access systems and access arrangements in vehicles use electronic security systems in which, for authentication of a user, data is transferred between a communication device of a portable user identification device, such as a key or key fob, and a second communication device of the vehicle. If the authentication is successful, a closure system of the vehicle is instructed to deactivate the locking of a specific vehicle door or all vehicle doors.

In so-called active access systems and/or access methods, the authentication is initiated by a user pressing a specific key of the user identification device provided for unlocking the vehicle, which in a capacity as a remote control then sends an unlocking signal to the vehicle. In passive access systems and/or methods an authentication procedure is initiated, for example, by contact with integrated proximity sensors or locking sensors in a door handle of the vehicle, the vehicle sending a code-request signal to the user identification device in response to the contact, which after receiving the request signal eventually sends a response signal back to the vehicle with the corresponding authentication code. Verification of the received code may take place, therefore, in the vehicle and in the event of positive and/or successful verification, as already mentioned above, the locking of the vehicle doors is deactivated. It is, therefore, possible for a user identification device, for example in the form of an (electronic) key, to be designed both for an active and a passive access method.

In particular, in such user identification devices which may carry out a plurality of functions, it may arise that the charged state of the battery of the user identification device drops rapidly (in comparison with a user identification device of simple design, for example with only one active access function) and thus the user identification device may no longer be able to be used for communication with the part of the access system on the vehicle side. This has the drawback that a user who would like to use the user identification device for obtaining access to his/her vehicle, only identifies that the user identification device has a malfunction and/or no longer produces any kind of function, and does not know whether the entire user identification device is defective or merely that the battery is low.

### SUMMARY

According to various embodiments, a simple means can be provided to indicate to a user of a user identification device a charged state of an energy source of the user identification device which is no longer satisfactory and/or sufficient.

According to an embodiment, a user identification device for an access system and/or starting system of a vehicle may comprise the following features: an energy source for making available a supply voltage for the user identification device; a measuring device for sensing the supply voltage currently made available by the energy source; an open-loop control and evaluation device for comparing the current sensed supply voltage with a first predetermined threshold value voltage and for deactivating at least one specific function of a plurality of functions which may be carried out by the open-loop control and evaluation device when the current sensed supply voltage drops below the first predetermined threshold value voltage.

According to a further embodiment, when dropping below the current sensed supply voltage of a second predetermined threshold value voltage which is lower than the first predetermined threshold value voltage, the open-loop control and evaluation device may deactivate a further specific function which may be carried out by the open-loop control and evaluation device. According to a further embodiment, the functions which may be carried out by the open-loop control and evaluation device can be prioritized relative to their operational relevance. According to a further embodiment, the functions which may be carried out by the open-loop control and evaluation device may have at least one passive function for the operation of a passive access system and at least one active function for the operation of an active access system, at least one passive function being deactivated when dropping below the first predetermined supply voltage. According to a further embodiment, the open-loop control and evaluation device may deactivate the at least one active function for the operation of an active access system, when dropping below the second predetermined threshold value voltage. According to a further embodiment, the open-loop control and evaluation device further may comprise a function for an emergency operation of the user identification device and/or a function for the operation of the starting system of the vehicle which is maintained after deactivation of the one specific and/or further specific function of the plurality of functions which may also be carried out by the open-loop control and evaluation device. According to a further embodiment, the open-loop control and evaluation device, when exceeding the second predetermined threshold value voltage, may activate the deactivated further function and/or when exceeding the first predetermined threshold value voltage reactivates the deactivated function. According to a further embodiment, the open-loop control and evaluation device, after identifying that the predetermined threshold value voltage has been dropped below, may send a signal to the vehicle in which information is contained relative to the dropping below of the predetermined threshold voltage.

According to another embodiment, a method for operating a user identification device for an access system and/or starting system of a vehicle may comprise the following steps: sensing the current supply voltage which is made available by an energy source of the user identification device; comparing the current sensed supply voltage with a first predetermined threshold value voltage; deactivating a specific function of a plurality of functions which may be carried out by the user identification device, when the current sensed supply voltage is lower than the first predetermined threshold value voltage.

According to yet another embodiment, an access system and/or starting system for a vehicle may comprise the following features: a starting arrangement on the vehicle side for starting a drive motor of the vehicle and/or a door closure arrangement on the vehicle side for locking and unlocking the vehicle; a communication device on the vehicle side for communication with a user identification device, the communication device on the vehicle side being connected to the starting arrangement on the vehicle side and/or the door closure arrangement on the vehicle side, in order to activate at least one of the arrangements depending on a received signal on the user identification device side; a user identification device as described above, which further comprises a communication device on the user identification side for communication with the communication device on the vehicle side.

### BRIEF DESCRIPTION OF THE DRAWINGS

Exemplary embodiments are now to be described hereinafter in more detail, with reference to the accompanying drawing, in which:

FIG. 1 shows a schematic representation of a user identification device within the context of an access system and starting system of a vehicle, in particular of a motor vehicle.

### DETAILED DESCRIPTION

According to various embodiments, a user identification device for an access system and/or starting system of a vehicle comprises an energy source and/or an energy storage device for storing electrical energy and for making available a supply voltage for the user identification device. The supply voltage is thus dependent on the charged state of the energy source and/or the electrical energy stored in the energy source. The energy source may in this connection be configured as a rechargeable energy source, for example in the form of a battery and/or an accumulator. Moreover, the user identification device comprises a measuring device for sensing the supply voltage currently made available by the energy source. Finally, the user identification device also comprises an open-loop control and evaluation device for comparing the current sensed supply voltage with a first predetermined threshold value voltage and for deactivating and/or switching off at least one (first) specific function of a plurality of functions which may be carried out by the open-loop control and evaluation device, when the current sensed supply voltage has dropped below the first predetermined threshold value voltage. In other words, when dropping below the first predetermined threshold value voltage one or more specific functions which may be carried out by the open-loop control and evaluation device may be maintained, whilst one or more other functions are deactivated and/or not longer able to be carried out. In particular, when the user knows which specific function is deactivated when reaching and/or dropping below a critical (first predetermined) threshold value voltage of the open-loop control and evaluation device, the user may rapidly conclude therefrom that the charged state of the energy source has reached a critical value and, for example, a replacement of the energy source is required. The deactivation, in a critical charged state of the energy source, of specific functions which are able to be carried out whilst other specific functions still remain activated, may thus be regarded as a simple means and/or as a means with minimal (additional) technical complexity to signal to the user a low energy source of the user identification device.

According to an embodiment, when dropping below the current sensed supply voltage of a second predetermined threshold value voltage which is lower than the first predetermined threshold value voltage, the open-loop control and evaluation device may deactivate at least one further (second) specific function which may be carried out by the open-loop control and evaluation device. By the deactivation of one or more further functions when a further critical charged state of the energy source is reached, whilst for example specific other functions which may be carried out by the open-loop control and evaluation device are still active, the user of a user identification device may, therefore, be presented with improved clarification about the charged state.

The sequence in which the functions which may be carried out by the open-loop control and evaluation device are deactivated, when reaching a critical charged state and/or a predetermined threshold value voltage of the energy source, may take place depending on the classification of the respective functions which may be carried out, according to their relevance for the operation of the access system and/or starting system for the vehicle. In other words, when reaching and/or dropping below the first predetermined threshold value voltage, initially those functions may be deactivated which have the lowest priority and/or the least relevance for the access system and/or starting system. For example, the plurality of functions which may be carried out by the open-loop control and evaluation device may have at least one function (active function) for the operation of an active access system and at least one function (passive function) for the operation of a passive access system, initially the at least one function for the operation of a passive access system being deactivated when dropping below the first predetermined supply voltage, whilst the at least one function for the operation of the active access system still remaining activated. In this connection it is, however, conceivable that, on the other hand, there is a plurality of functions for the operation of a passive access system, only a proportion of these functions for the operation of a passive access system being deactivated when dropping below the first predetermined supply voltage, with other passive functions still remaining activated. Accordingly, it is also conceivable that there is a plurality of functions for the operation of an active access system, a proportion of the active functions being deactivated when dropping below the first predetermined supply voltage, with other active functions remaining activated.

In this connection, it is also conceivable that the open-loop control and evaluation device deactivates the at least one function (all or a proportion of the functions) for the operation of an active access system, when dropping below the second predetermined threshold value voltage. Finally, it is conceivable that the open-loop control and evaluation device, in addition to the at least one active and at least one passive function for the operation of an active and/or passive access system has further functions which are maintained, even after deactivating the at least one active and/or passive function which may be carried out by the open-loop control and evaluation device. These functions may, for example, comprise a function for the operation of the starting system of the vehicle, i.e. a function for transmitting coded information for deactivating an engine immobilizer and/or for starting the drive motor of the vehicle. Moreover, these further functions may comprise an emergency operation function for the user identification device, by which, for example, the charging of the energy source of the user identification device is made possible by a wired connection to an external energy source or by an external electromagnetic alternating field (inductive).

If the energy source of the user identification device is recharged and/or the “weak” energy source of the user identification device has been replaced by a satisfactorily charged energy source, the open-loop control and evaluation device is designed, when identifying that the current supply voltage of the energy source has again exceeded the first and/or second predetermined threshold, to reactivate the previously deactivated functions. Thus, when identifying a satisfactorily charged state it is possible for a user identification device to be fully reactivated.

According to a further embodiment of the user identification device, said user identification device further comprises a display device which emits to a user in an optical, acoustic or mechanical manner the charged state of the energy source and/or the supply voltage currently made available by the energy source. It is, however, also conceivable that the display device only emits a signal for a user when a supply voltage has just reached or dropped below a predetermined threshold value.

According to a further embodiment, the user identification device and/or the open-loop control and evaluation device thereof, after identifying when dropping below the predetermined threshold value voltage, may send a signal to the vehicle in which information relating to the dropping below of the predetermined threshold value voltage is contained. Thus, the vehicle and/or in particular the access system and/or starting system thereof may implement suitable measures in order to continue to permit the security of the access system and/or starting system or in order to display to a user of the user identification device that the predetermined threshold value voltage has been dropped below, by display means on the vehicle side.

According to a further embodiment, the user identification device is configured as a portable device and/or as a device which may be carried by a user, for example in the form of an (electronic) key or a keycard. In particular, in the case of portable user identification devices, in which small dimensions are desired for the purpose of easy manageability for the user, the space for the energy source and the energy storage capacity thereof is also limited.

Thus, by means of an energy management system according to various embodiments as a result of the continuous monitoring of the supply voltage, the maintenance of specific functions is ensured as long as possible and, as a result, the comfort of the user.

According to a further embodiment, a method for operating a user identification device is provided for a starting system and/or access system of a vehicle. In this connection, the current supply voltage which is provided by an energy source of the user identification device, is initially sensed. Then the current sensed supply voltage is compared with a first predetermined threshold value voltage. Finally, at least one specific function of a plurality of functions which may be carried out by the user identification device is deactivated, when the current sensed supply voltage is lower than the first predetermined threshold value voltage. By this method, it is therefore possible by deactivating one or more specific functions when reaching a critical threshold value voltage, whilst other functions still remain activated, to signal to a user that the energy source of the user identification device no longer has a satisfactorily charged state.

Further embodiments of the user identification device shown above, insofar as they are also able to be transferred to the method, may also be regarded as embodiments of the method.

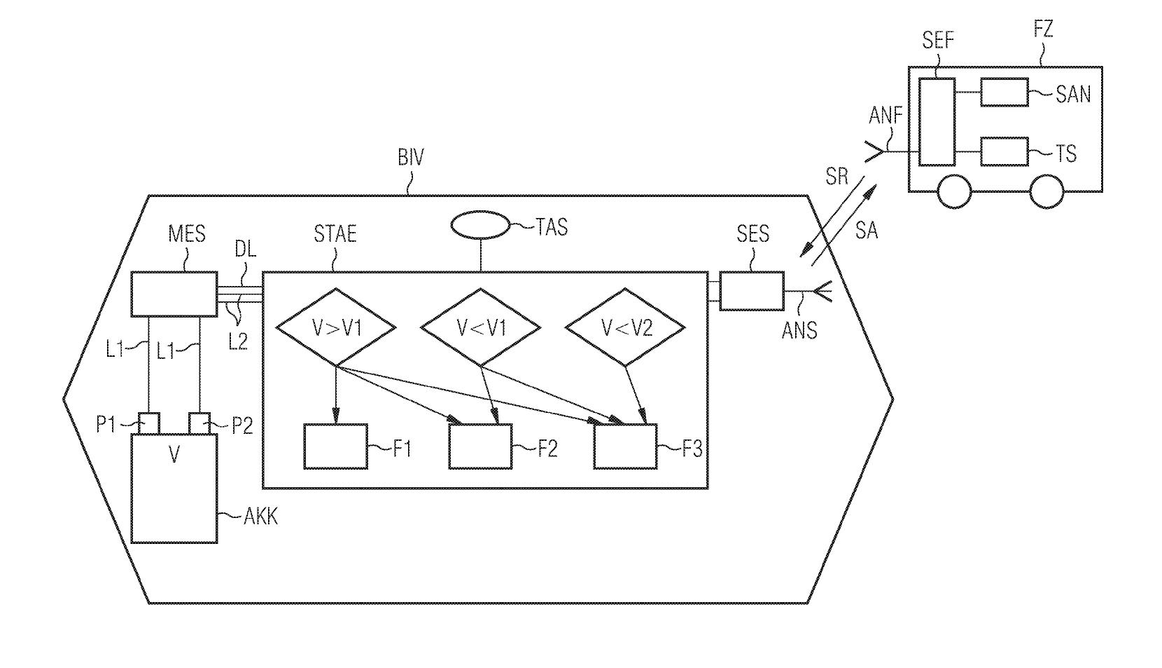

Reference is now made to FIG. 1 in which the schematic structure of a user identification device BIV is shown for an access system and starting system of a vehicle FZ. The user identification device BIV may thus be configured as a portable device in the form of an (electronic) key and/or a key fob, which a user of the vehicle FZ may carry. In this connection, the user identification device BIV has an energy storage device and/or an energy source, which in this case is configured as an accumulator AKK. The accumulator AKK provides, therefore, a supply voltage V at two poles P1 and P2, which depends on the charged state of the accumulator. Said supply voltage which is made available by the accumulator is supplied via electrical cables L1 to a measuring device, in this case to a voltage measuring device MES by which the supply voltage and/or the current supply voltage V made available by the accumulator is measured and is provided via cables L2 to an open-loop control and evaluation device STAE. The result of the measurement and/or the currently sensed supply voltage is conducted from the measuring device MES via a data cable DL to the open-loop control and evaluation device STAE. Although, for illustrating the embodiment, the measuring device MES and the open-loop control and evaluation device STAE are shown as two separate devices, it is also conceivable that the measuring device MES is integrated in the open-loop control and evaluation device STAE and/or is configured integrally therewith.

The open-loop control and evaluation device STAE is able to carry out a plurality of functions F1, F2, F3. The function identified by F1 may thus have one or more functions (passive functions) for the operation of a passive access system. Such a function for the operation of a passive access system may be that the user identification device BIV (and/or the open-loop control and evaluation device STAE) responding to a request signal SR (as will be explained below in more detail) produces one or more response signals SA, in which a specific identification code of the user identification device BIV is transmitted. In other words, in contrast to a function for an active access system, the function for the operation of the passive access system serves to produce and to transmit the one response signal or the plurality of response signals SA for coded transmission, responding to a (request) signal of the vehicle FZ and not to an actuation of a key TAS by a user.

The function F2, in contrast, represents a function (active function) for the operation of an active access system, in which the transmission of a signal SA with coded information is triggered by pressing the key TAS by a user. In other words, in this case the user has to carry the user identification device BIV separately by hand and by pressing the key TAS express a request for unlocking the vehicle.

Finally, the function F3 represents one or more functions which are very important for the operation of the vehicle, such as for example a function for deactivating an engine immobilizer and/or for starting the drive motor of the vehicle FZ. In particular, when the user is located together with the user identification device BIV in the interior and/or passenger compartment of the vehicle FZ, in this case within the context of a dialogue—triggered by a transmitting and receiving device on the vehicle side—a code is transmitted on the user identification device side, the engine immobilizer being deactivated and/or the drive motor of the vehicle FZ being activated in the event of satisfactory identification.

It is, however, also possible that as a result of the function F3 an emergency operation function is represented which makes it possible, in the case of a supply voltage which is too low, to charge the accumulator inductively by an external energy source.

The respective functions F1, F2, F3 are thus prioritized differently, the function F2 having greater operational relevance for the access system of the vehicle than the function F1. The function F3, however, has a higher priority than the two functions F2 and F1.

The functions F1 to F3 previously shown above all require a transmitting/receiving device SES for carrying out said functions, which has an antenna ANS for receiving request signals SR and/or for transmitting response signals or control signals SA.

As it may arise that by carrying out the numerous functions F1 to F3 the accumulator AKK becomes “weak” and/or the charged state thereof and thus the supply voltage V thereof drop, specific functions or all of the functions F1 to F3 are no longer able to be carried out satisfactorily in such a “weak” state. In order to enable, however, specific functions which are, in particular, important for the operation of the access system and/or the starting system, to be maintained as long as possible, the supply voltage V currently measured by the measuring device MES is monitored regularly by the open-loop control and evaluation device and, when reaching specific threshold value voltages, specific functions which are less important for the operation of the access system or starting system are deactivated according to a predetermined sequence.

If the accumulator AKK has a supply voltage V which is greater than a first predetermined threshold value and/or greater than a first threshold value voltage V1, the supply voltage is classified as satisfactory and all functions F1 to F3 are enabled for implementation by the open-loop control and evaluation device STAE (identified by three arrows in each case for one of the functions F1 to F3, starting from the first conditional box for the supply voltage V).

If a supply voltage V is detected by the measuring device MES, which is lower than the first predetermined threshold value voltage V1 (identified by the second or central conditional box), which indicates a charged state of the accumulator which is no longer satisfactory, the function which is the least important for the operation of an access system, namely the function F1 for the operation of a passive access system is deactivated by the open-loop control and evaluation device STAE (characterized in that starting from the second conditional box for the supply voltage only two arrows indicate the functions F2 and F3). As the function F1 represents a more or less extra function for a user, and is not necessarily required for obtaining access to the vehicle, in such a “weak” state of the accumulator the function F1 may be dispensed with. In order to obtain access to the vehicle, the user now has to use the function F2 for the operation of the active access system and by pressing the key TAS express a request for access to the vehicle. The deactivation of the function F1 may, for example, be effected by a wake-up-pattern containing a request signal SR being deleted, which has the result that the user identification device BIV no longer reacts to incoming and/or received request signals SR and no longer transmits corresponding response signals SA. In any case, by deactivating the function F1 the accumulator is not overworked, in order to permit longer availability of the other two functions F2 and F3.

It is now also possible that after further operation of the user identification device BIV (and after possibly repeatedly carrying out the function F2) the supply voltage V made available by the accumulator AKK drops further and reaches and falls below a second threshold value and/or a second threshold value voltage V2 (identified by the third conditional box for the supply voltage V), so that in this case the open-loop control and evaluation device STAE finally also deactivates the second function F2, in order to save energy for maintaining the third function F3. More specifically, it is no longer possible in this state to use the active access system, in order to unlock the vehicle FZ by means of the user identification device BIV, but this may take place in a conventional manner with a mechanical key bit which is inserted into a locking cylinder on the vehicle. After mechanically unlocking and entering the passenger compartment, as the function F3 is still active, the driver may now effect a deactivation of the engine immobilizer and/or starting of the drive motor (such as for example an internal combustion engine) of the vehicle FZ, as within the scope of the function F3—triggered by a reader device and/or transmitting/receiving device SEF of the vehicle—a response signal SA may be produced by the open-loop control and evaluation device STAE, and may be transmitted from the transmitting/receiving device SES of the user identification device, which with positive verification permits the deactivation of the engine immobilizer and/or the starting of the drive motor and thus the operational readiness of the vehicle FZ.

In the state in which the supply voltage V is lower than the second threshold value V2, it is also possible to effect an emergency operation function for the user identification device BIV, in which for example the user identification device BIV is kept in the immediate vicinity of the antenna ANF of the transmitting/receiving device SEF of the vehicle FZ, for example the weak accumulator state of the user identification device BIV being indicated by repeated contact in quick succession with locking sensors in a door handle of the vehicle, whereby the transmitting/receiving device SEF transmits request signals via the antenna ANF using high energy and/or power, by which the accumulator AKK after receiving the request signals by means of the antenna ANS and the transmitting/receiving device SES may be recharged to a satisfactory state. If, during such an emergency operation, the charged state of the accumulator has again reached a satisfactory value and/or the supply voltage V of the accumulator AKK has again reached a satisfactory value, the open-loop control and evaluation device STAE will reactivate the previously deactivated functions F1 and F2.

For the sake of completeness, reference is briefly made to the essential components of the access system and/or starting system of the vehicle. As already mentioned, within the context of an access system, control signals and/or response signals SA are conducted by the antenna ANF to the transmitting/receiving device SEF, which then with positive verification of one or more codes contained in the signals SA, transmits an instruction to a door closure system TS of the vehicle, so that one or more vehicle doors (not shown) are unlocked. Accordingly, within the context of the starting system a code contained in the response signal SA is verified by the transmitting/receiving device SEF on the vehicle side, and with positive verification, a starting arrangement SAN is activated which effects the deactivation of an engine immobilizer and/or the activation of the drive motor of the vehicle.

Although, according to the embodiment shown above, it is possible that the function F1 refers to all functions which are relevant to the operation of a passive access system, it is conceivable that only a proportion of the functions which are relevant for the operation of a passive access system is represented by the function F1. According to a particular embodiment of a passive access system it is possible that the user identification device BIV transmits signals spontaneously at a predetermined field strength (polling), in order to identify, when obtaining a corresponding response signal from the vehicle FZ, whether the vehicle FZ is at a defined distance from the user identification device BIV. For example, by this polling function, when the user identification device BIV approaches the vehicle FZ, welcome lighting is activated at a specific distance or when the user identification device BIV is moved away from the vehicle and thus exceeds a defined distance from the vehicle, an automatic locking of the vehicle (walk-away-locking) may be carried out. As this polling function continuously uses up energy due to the regular transmission of request signals and/or radio signals, for example when reaching the state in which the supply voltage V of the accumulator AKK has dropped below the first threshold value voltage V1, this polling function (shown as function F1 in the figure) may be deactivated. Further functions for the operation of a passive access system, which merely effect the reception of the request signal SR on the vehicle side and the transmission of response signals SA in response to the request signal SR, may be represented, for example, by the function F2, which has a greater relevance for the operation of the access system than the function F1. In this manner, according to the embodiment set forth with a low charged state of the accumulator AKK the “normal” operation of a passive access system may still be obtained, at least until the supply voltage V of the accumulator AKK has dropped below the second threshold value voltage V2. By the successive deactivation of specific functions depending on the charged state of the accumulator AKK, specific other functions also remain activated, feedback may thus be communicated to the user of the user identification device BIV about an accumulator of the user identification device BIV becoming weak, without additional display devices being necessary.

It should also be mentioned that, according to a further embodiment of a passive access system, for example for producing the above-mentioned “welcome lighting” or “walk-away-locking” comfort functions, it is also possible that, rather than the user identification device, it is the vehicle FZ which spontaneously transmits signals at a predetermined field strength (polling), in order to identify when obtaining a corresponding response signal from the user identification device BIV, whether the user identification device BIV is at a defined distance from the vehicle FZ. As the response to the polling of the vehicle on the part of the user identification device BIV also continuously uses up energy, for example when reaching the state in which the supply voltage V of the accumulator AKK of the user identification device BIV has dropped below the first threshold value voltage V1, this response function (represented as function F1 in the figure) may be deactivated.

In addition to the case of deactivating one or more specific functions when reaching a predetermined threshold value of the supply voltage of the energy source of the user identification device, generally (i.e. additionally or instead of the deactivation) there is also the possibility when reaching a predetermined threshold value of the supply voltage to activate one or more of the functions able to be carried out by the user identification device and/or the open-loop control and evaluation device thereof or to carry out said functions directly, responding to a detection of the predetermined (low) threshold value, as in the case of the threshold value V1. Thus, for example, it is conceivable that the user identification device and/or the control and evaluation device thereof, when identifying a supply voltage value currently made available by the energy source, which is lower than or the same as a predetermined (low) threshold value, such as the threshold value V1 and/or the threshold value V2, instructs the transmitting/receiving device SES to send a status signal with information about the inadequate state of the energy source and/or of the supply voltage which is no longer satisfactory to the vehicle FZ via the antenna ANS. After the vehicle has received this status signal via the transmitting/receiving device SEF, it may use the information about the state of the energy source of the user identification device which is no longer satisfactory, for example, to adapt the above-mentioned “welcome lighting” or “walk-away-locking” comfort functions to the new situation. Relative thereto, for increasing and/or maintaining the security of the access system of the vehicle within the scope of “walk-away-locking” the vehicle and/or the transmitting/receiving device SEF thereof, as soon as the user identification device has passed from the vehicle interior to the exterior of the vehicle, may instruct the door closure system TS to lock the doors of the vehicle, without waiting until the key exceeds a specific distance from the vehicle. Accordingly, after obtaining with the “welcome lighting” the information about the state of the energy source of the user identification device which is no longer satisfactory, the vehicle may alter the welcome lighting by, for example, instead of a permanent or continuous illumination in the satisfactory state, flashing now being used for the welcome lighting in the case of a state of the energy source of the user identification device which is no longer satisfactory. In this case, therefore, the “display means” of the vehicle may be directly used for displaying the state of the energy source of the user identification device which is no longer satisfactory, without having to alter slightly or add additional technical devices to the user identification device. It should be mentioned that a display in the vehicle, for example on the dashboard, may also indicate the (charged) state of the energy source of the user identification device, after the vehicle has received a status signal from the user identification device.

What is claimed is:

1. A user identification device for at least one of an access system and a starting system of a vehicle comprising:
an energy source for making available a supply voltage for the user identification device;
a measuring device for sensing the supply voltage currently made available by the energy source;
an open-loop control and evaluation device for comparing the current sensed supply voltage with a first predetermined threshold value voltage and for deactivating at least one specific function of a plurality of functions which may be carried out by the open-loop control and evaluation device when the current sensed supply voltage drops below the first predetermined threshold value voltage.

2. The user identification device according to claim 1, wherein when dropping below the current sensed supply voltage of a second predetermined threshold value voltage which is lower than the first predetermined threshold value voltage, the open-loop control and evaluation device deactivates a further specific function which may be carried out by the open-loop control and evaluation device.

3. The user identification device according to claim 1, wherein the functions which may be carried out by the open-loop control and evaluation device are prioritized relative to their operational relevance.

4. The user identification device according to claim 1, wherein the functions which may be carried out by the open-loop control and evaluation device have at least one passive function for the operation of a passive access system and at least one active function for the operation of an active access system, at least one passive function being deactivated when dropping below the first predetermined supply voltage.

5. The user identification device according to claim 4, wherein the open-loop control and evaluation device deactivates the at least one active function for the operation of an active access system, when dropping below the second predetermined threshold value voltage.

6. The user identification device according to claim 1 wherein the open-loop control and evaluation device further comprises at least one of a function for an emergency operation of the user identification device, a function for the operation of the starting system of the vehicle which is maintained after deactivation of the one specific, and a further specific function of the plurality of functions which may also be carried out by the open-loop control and evaluation device.

7. The user identification device according to claim 1, wherein the open-loop control and evaluation device at least one of when exceeding the second predetermined threshold value voltage activates the deactivated further function and when exceeding the first predetermined threshold value voltage reactivates the deactivated function.

8. The user identification device according to claim 1, wherein the open-loop control and evaluation device, after identifying that the predetermined threshold value voltage V—)—been dropped below, sends a signal to the vehicle in which information is contained relative to the dropping below of the predetermined threshold voltage (V1).

9. A method for operating a user identification device for at least one of an access system and a starting system of a vehicle comprises the following steps:
sensing the current supply voltage which is made available by an energy source of the user identification device;
comparing the current sensed supply voltage with a first predetermined threshold value voltage;
deactivating a specific function of a plurality of functions which may be carried out by the user identification device, when the current sensed supply voltage is lower than the first predetermined threshold value voltage.

10. A system for a vehicle comprising a user identification device according to claim 1 and further comprisng:
at least one of a starting arrangement on the vehicle side for starting a drive motor of the vehicle and a door closure arrangement on the vehicle side for locking and unlocking the vehicle;
a communication device on the vehicle side for communication with a user identification device, the communication device on the vehicle side being connected to at least one of the starting arrangement on the vehicle side and the door closure arrangement on the vehicle side, in order to activate at least one of the arrangements depending on a received signal on the user identification device side;
wherein they user identification device further comprises a communication device on the user identification side for communication with the communication device on the vehicle side.

11. The method according to claim 9, wherein when dropping below the current sensed supply voltage of a second predetermined threshold value voltage which is lower than the first predetermined threshold value voltage, deactivating a further specific function.

12. The method according to claim 9, wherein the functions which may be carried out are prioritized relative to their operational relevance.

13. The method according to claim 9, wherein the functions which may be carried out have at least one passive function for the operation of a passive access system and at least one active function for the operation of an active access system, at least one passive function being deactivated when dropping below the first predetermined supply voltage.

14. The method according to claim 13, further comprising the step of deactivating the at least one active function for the operation of an active access system, when dropping below the second predetermined threshold value voltage.

15. The method according to claim 9, further comprising at least one of a function for an emergency operation of the user identification device, a function for the operation of the starting system of the vehicle which is maintained after deactivation of the one specific, and a further specific function of the plurality of functions.

16. The method according to claim 9, performing at least one of when exceeding the second predetermined threshold value voltage, activating the deactivated further function and when exceeding the first predetermined threshold value voltage, reactivating the deactivated function.

17. The method according to claim 9, after identifying that the predetermined threshold value voltage has been dropped below, sending a signal to the vehicle in which information is contained relative to the dropping below of the predetermined threshold voltage.

18. The system according to claim 10, wherein when dropping below the current sensed supply voltage of a second predetermined threshold value voltage which is lower than the first predetermined threshold value voltage, the open-loop control and evaluation device deactivates a further specific function which may be carried out by the open-loop control and evaluation device.

19. The system according to claim 10, wherein the functions which may be carried out by the open-loop control and evaluation device are prioritized relative to their operational relevance.

20. The system according to claim 10, wherein the functions which may be carried out by the open-loop control and evaluation device have at least one passive function for the operation of a passive access system and at least one active function for the operation of an active access system, at least one passive function being deactivated when dropping below the first predetermined supply voltage.
